(19) United States
(12) Patent Application Publication
(10) Pub. No.: US 2005/0171752 A1
(43) Pub. Date: Aug. 4, 2005

(54) Failure-response simulator for computer clusters

(76) Inventors: Jonathan Paul Patrizio, San Francisco, CA (US); Eric Martin Soderberg, Mountain View, CA (US); James Russell Curtis, Placerville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/767,524

(22) Filed: Jan. 29, 2004

(51) Int. Cl. G06F 17/50

(52) U.S. Cl. 703/17

(57) ABSTRACT

A cluster simulator simulates reformation of a real cluster in response to failure events. Profile programs on the cluster can gather data useful to the simulation and transmit the profile data to the simulator. The simulator can generate a model of the real cluster, the model itself being a virtual cluster. A user can select virtual failure events from a menu to apply to the model and the simulator responds by generating a post-failure virtual cluster in the configuration that the real cluster would assume in the event of the corresponding real failure. Sequences of virtual failures can also be tested for a given cluster configuration to evaluate its robustness. Comprehensive testing using virtual failure sequences can also be applied to different cluster configuration so that an optimum configuration can be recommended.

### BACKGROUND OF THE INVENTION

The present invention relates to computers and, more particularly, to a computer simulation system. A major objective of the invention is to provide for convenient evaluation of the robustness of a computer cluster when confronted with various failure scenarios.

Modern society has been revolutionized by the increasing prevalence of computers. As computers have occupied increasingly central roles, their continued operation has become increasingly critical. For example, the cost of lengthy downtime for an on-line retailer during a peak shopping period can be unacceptable.

High-availability computer clusters have been developed to minimize downtime for mission-critical applications. For example, in a cluster with two computers, if one of the computers fails, an application that was running on the failed computer can be migrated to the still operational computer by launching a previously inactive instance of the application on the latter computer. In addition, a logical network address formerly associated with the failed computer can be migrated to the adopting computer so that those accessing the application over a network can continue using the same network address for the application.

More complex clusters can include more computers, more networks, and more complex high-availability components. There are then more possible points of failure, more possible combinations of failures, and more alternatives for migrating software in the event of failures. As clusters become more complex, it can be more difficult to determine what failure conditions can be tolerated and which cannot. Accordingly, it can be difficult to determine what cluster design is most cost-effective for a given situation, what configuration is most effective for a given cluster, and which failures require immediate attention.

To address these problems, elaborate sets of cluster design and configuration guidelines have been developed. In addition, extensive testing can be done once a cluster has been installed. For example, one can break various connections manually to induce failures and then check the newly configured cluster's response. However, such testing is limited in effectiveness and can induce unintended failures (e.g., as a connection fails to reestablish).

Furthermore, such testing is not an attractive option once a cluster is actually employed for a mission-critical purpose. Owners may be reluctant to upgrade, expand, or reconfigure clusters that are in-use, and thus not benefit from available improvements because testing is too costly or risky. What is needed is a more convenient and less risky system for testing availability for computer clusters.

### SUMMARY OF THE INVENTION

The present invention provides a system for simulating a computer cluster's change from a pre-failure configuration to a post-failure configuration in response to a real failure event. The simulator generates a virtual cluster in a virtual pre-failure configuration that is a model of the real cluster in its real pre-failure configuration. The simulator provides for selection of a virtual-failure event to be applied to the virtual cluster. In response to a selection of a virtual-failure event corresponding to the aforementioned real failure event, the simulator generates said virtual cluster in a virtual post-failure configuration that is a model of said cluster in a respective real post-failure configuration. In addition to allowing selection of single-point failures, the invention provides for selection of combinations and sequences of single-point failures to be applied to a virtual cluster.

The invention provides for evaluating virtual cluster configurations (and, therefore, the corresponding real clusters). The evaluation can be as simple as distinguishing clusters in which all the intended applications are available from those in which not all the intended applications are available. The invention also provides for more refined evaluations, such as distinguishing configurations in which some but not all intended applications are available. Further evaluation can address cluster resource utilization for each configuration.

The invention provides for comprehensive testing of a cluster configuration for a range of failures, e.g., to demonstrate the robustness of the cluster configuration. The cluster configurations resulting from each failure selection can be evaluated and compared, e.g., for use in advising as to the urgency of a repair. The invention further provides for testing multiple configurations of a cluster, e.g., for recommending an optimum configuration.

The simulator can run on a cluster or, preferably, be connected to the cluster over a network. In this case, the invention provides for profile programs run on the cluster to gather configuration and other information relevant to model generation and to transmit the information to the simulator for use in generating a current model of the cluster. The simulator can be used to test the robustness of the current configuration and/or make recommendations as to an optimum configuration. In the latter case, the invention provides for feeding back an optimum configuration to be implemented automatically by the cluster. Otherwise, recommendations can be manually implemented.

While the invention provides for simulation of an actual cluster, it also provides for simulation of a potential (vs. actual) real (vs. virtual) cluster. Thus, the invention can also be used to compare different clusters over their respective configuration, e.g., to assist purchase, upgrade, and configuration decisions. These and other features and advantages of the invention are apparent from the description below with reference to the following drawings.

### BRIEF DESCRIPTION OF THE DRAWINGS

FIG. 1 is a schematic illustration of a computer system having a cluster and a simulator for the cluster.

FIG. 2 is a block diagram of a first node of the cluster of FIG. 1.

FIG. 3 is a block diagram of a second node of the cluster of FIG. 1.

FIG. 4 is a block diagram of a third node of the cluster of FIG. 1.

FIG. 5 is a block diagram of a simulator program used in the simulator of FIG. 1.

FIG. 6 is a flow chart of a method of the invention as practiced using the system of FIG. 1.

FIG. 7 is a schematic representation of a simulator display image obtainable using the system of FIG. 1.

FIG. 8A is a schematic representation of a second simulator display image obtainable using the system of FIG. 1.

FIG. 8B is a schematic representation of a third simulator display image obtainable using the system of FIG. 1.

In the figures, cluster daemons and profilers with relatively heavy lines are serving as cluster managers and cluster profilers, respectively.

### DETAILED DESCRIPTION

In accordance with the present invention, a computer system AP1 comprises a real computer cluster RCC, a simulator SIM, and a network NW0. Computer cluster hardware includes three computers, herein referred to as “nodes” N1, N2, and N3. Computer cluster RCC also has a mirrored disk array HD, and two subnetworks NW1 and NW2 of network NW0, coupled by a hub HB. Simulator SIM is coupled to hub HB by a third subnetwork NW3.

Simulator SIM includes a computer unit R11, a computer keyboard R13, a mouse R15, and a display R17. Display R17 displays graphics generated by computer unit R11 and also serves as a USB (Universal Serial Bus) hub coupling keyboard R13 and mouse R15 to computer unit R11. Computer simulator SIM is designed to simulate the response of computer cluster RCC to failure events. Accordingly, display R17 displays a menu V06 of virtual failure events that can be selected by a user. In addition, display R17 can show a “pre-failure” virtual cluster VC1, representing real cluster RCC in a pre-failure condition, and a “post-failure” virtual cluster, representing real cluster RCC in a post-failure configuration.

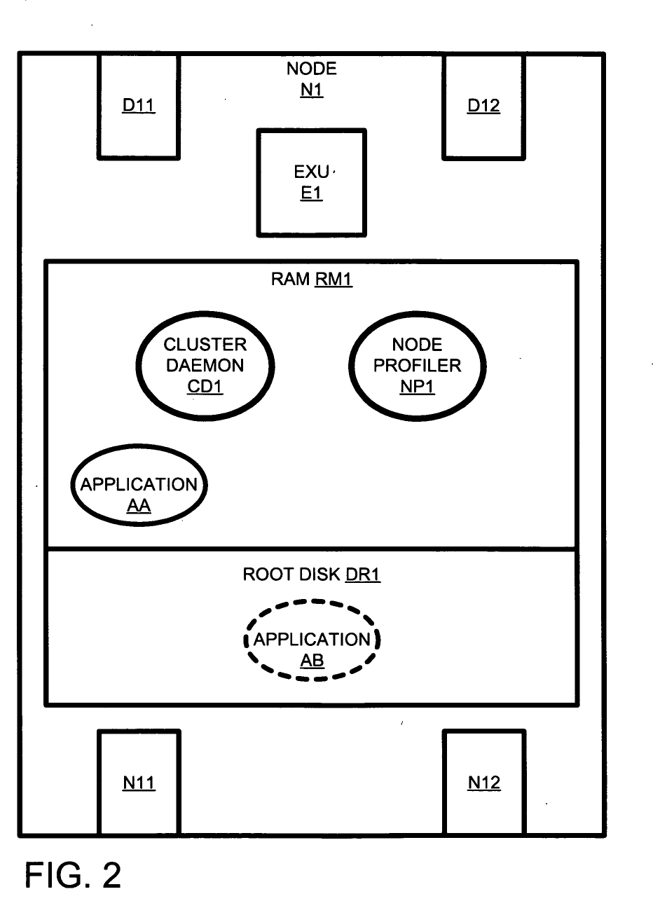

Node N1 is represented in greater detail in FIG. 2. Node N1 includes the following hardware: an execution unit EX1, solid-state random-access memory RM1, a root hard disk DR1, two hard-disk interfaces D11 and D12, and two network interfaces N11 and N12, which couple node N1 to subnetworks NW1 and NW2, respectively. Hard disk interfaces D11 and D12 couple node N1 to main-data and mirror disk subarrays of disk array HD, respectively.

The following software is installed and running on node N1: an application AA, cluster daemon CD1, and a node profiler N1. In addition, an application AB is installed but (as indicated by the dashed perimeter and its location outside of RAM RM1) not running on node N1; although not running, application AB is configured so that it can be run in response to a failure event requiring the reformation of cluster RCC.

Application AA can be thought of as representing the primary functionality of node N1; for example, application AA can be an order-taking application for an Internet vendor. Likewise, application AB can be a product database, and application AC can be an accounting system. Cluster daemon CD1 is part of the background software design to contribute to the continued availability of application AA (and other applications) in the event of certain failures. For example, application AA can be part of package migrated to another node in cluster RCC in the event node N1 becomes inoperable. The invention provides node profiler NP1 (and its counterparts on nodes N2 and N3) to gather node-specific hardware, software, and configuration data on behalf of simulator SIM.

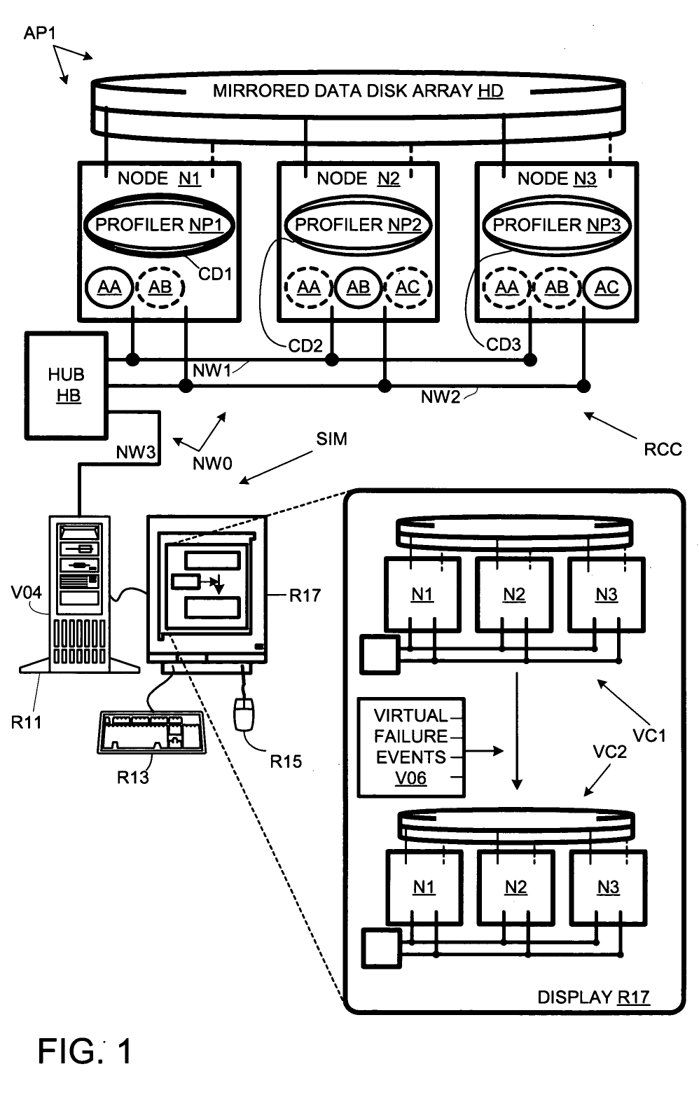

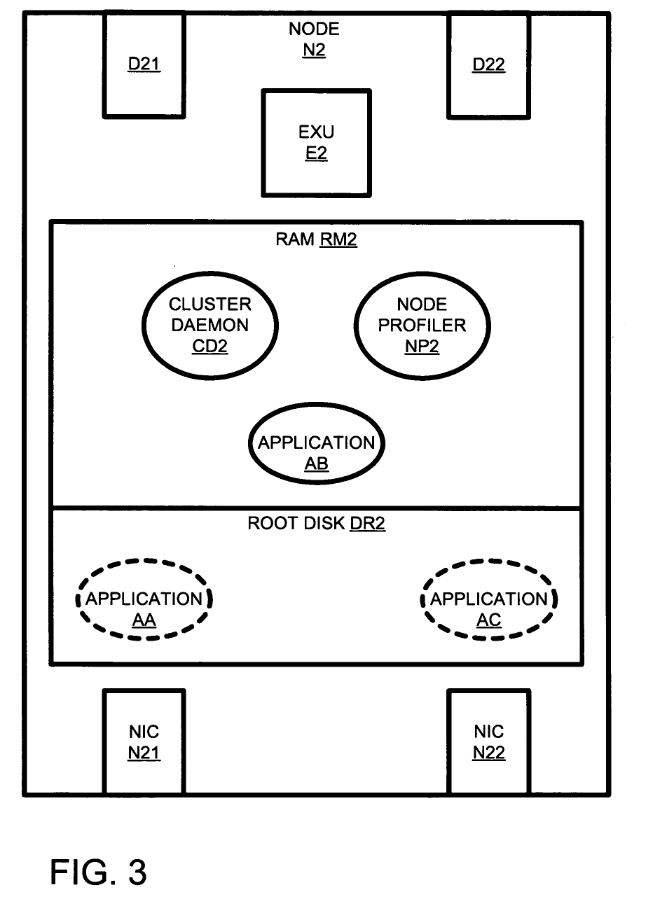

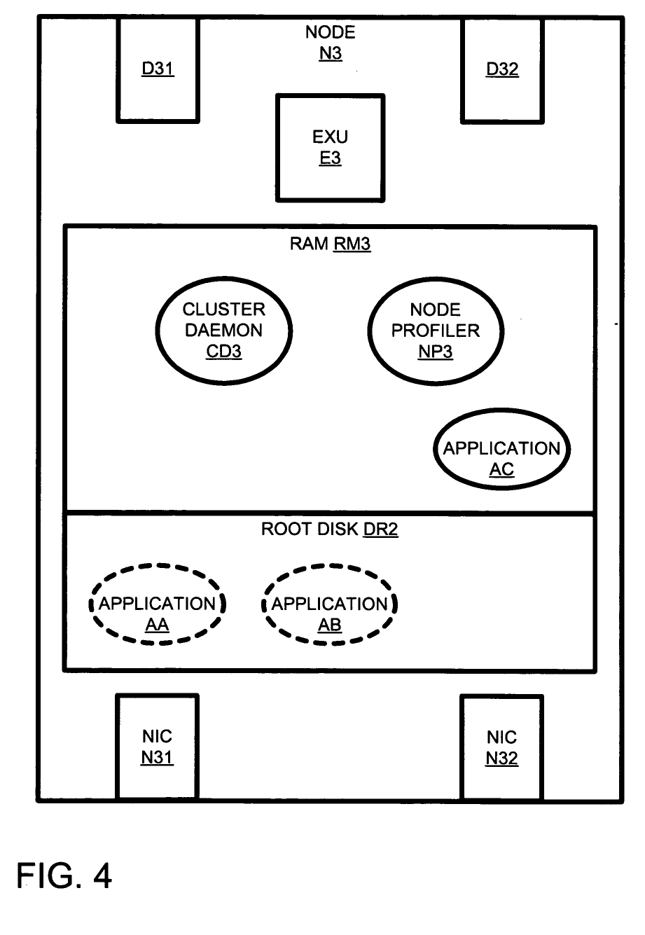

Cluster daemon CD1 and its counterparts on nodes N2 and N3 are processes that communicate with each other and define the failure-response character of cluster RCC. More specifically, cluster daemon CD1 is a component of Serviceguard cluster management software available from Hewlett-Packard Company. Cluster daemon CD1 is shown in FIG. 2 with a thicker line than are its counterparts CD2 and CD3 in FIGS. 3 and 4, to indicate that cluster daemon CD1 is acting as the cluster manager at the time represented in FIGS. 1-4. (Note that while ServiceGuard provides for applications that are installed but not configured to run even upon cluster reformation, there are no such applications in the illustrated embodiment.)

Node profiler NP1 and its counterparts on nodes N2 and N3 are processes that gather information about their host nodes that can be used in simulating cluster RCC. Since, in the initial configuration represented in FIGS. 1-4, cluster daemon CD1 is acting as the cluster manager, node profiler NP1 acts as a profiler not only for node N1, but also for cluster RCC as a whole. In other words, the node profiler on the node having the current cluster manager acts as information central for the profile data. The cluster profiler status of node profiler NP1 is indicated by the relatively thick line applied to it in FIG. 2.

As shown in FIG. 3, node N2 includes the following hardware:

an execution unit EX2, solid-state memory RM2, a root hard-disk DR2, two hard-disk interfaces D21 and D22, and two network interfaces N21 and N22. The functions of these hardware components are analogous to their counterparts on node N1. The following software is installed and running on node N2: cluster daemon CD2, node profiler NP2, and application AB. Applications AA and AC are installed and available to run on node N2, but are not running as cluster RCC is initially configured.

As shown in FIG. 4, node N3 includes the following hardware: an execution unit EX3, solid-state memory RM3, a root hard-disk DR3, two hard-disk interfaces D31 and D32, and two network interfaces N31 and N32. The functions of these hardware components are analogous to their counterparts on node N1. The following software is installed and running on node N3: cluster daemon CD3, node profiler NP3, and application AC. Applications AA and AB are installed and available to run on node N2, but are not running as cluster RCC is initially configured.

With cluster RCC configured as shown in FIG. 1, nodes N1, N2, and N3 communicate with each other using subnetwork NW1. Subnetwork NW2 is used for “heartbeat” messages. Cluster daemons CD1, CD2, and CD3 “listen” for heartbeats from the other nodes. If a predetermined number, typically one, of heart beats is missed from one of the nodes, that node is presumed to have failed. Accordingly, the cluster reforms without that node. If one of the networks fails, the other combines the functions of both networks. If a network interface card fails, the incorporating node migrates its function to the other network interface for both functions. If one node uses one subnetwork exclusively and the other uses another subnetwork exclusively, the nodes can still communicate since subnetworks NW1 and NW2 are connected by hub HB.

With cluster RCC in its initial configuration as shown in FIG. 1, nodes N1, N2, and N3 communicate with a main data subarray of mirror disk array HD. If one of the required hard-disk interfaces D11, D21, or D31 fails, the alternate interface D12, D22, or D32, provides access to the mirror subarray which contains a copy of all data on the main disk array. Root disks DR1, DR2, and DR3 normally include programs rather than data, so backup is achieved by simply storing program on more than one root disk. In an alternative embodiment, additional robustness can be achieved by mirroring the root disks as well as the shared disks.

In the initial configuration of cluster RCC, cluster daemon CD1 manages cluster RCC by coordinating its activities with those of cluster daemons CD2 and CD3 of nodes N2 and N3, respectively. Node profiler NP1 generates cluster profiles from the data it collects from node N1 and from the data collected by node profilers NP2 and NP3 of nodes N2 and N3, respectively. As cluster profiler, node profiler NP1 transmits cluster profiles to simulator SIM via subnetworks NW1 and NW3 and hub HB. The cluster profiles allow simulator SIM to maintain a current model of cluster RCC.

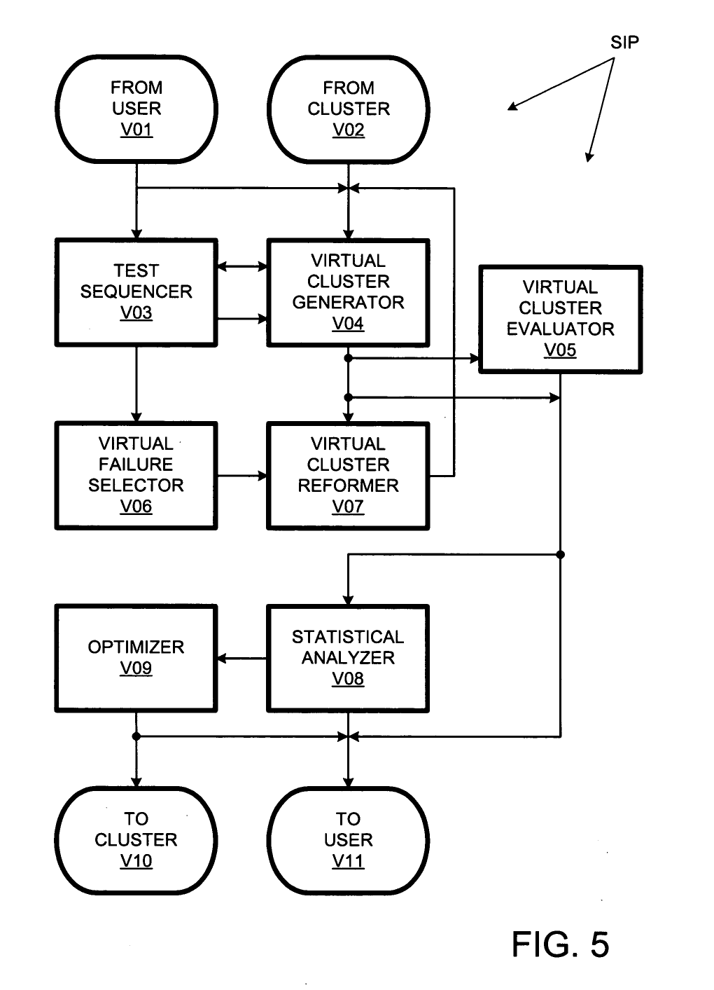

Simulator SIM includes a simulation program SIP including the following modules shown in FIG. 5: a user input V01, a network input (from cluster RCC) V02, a test sequencer V03, a virtual-cluster generator V04, a cluster evaluator V05, a failure selector V06, a model transformer V07, a statistical analyzer V08, an optimizer V09, a network output V10, and a user output V11. In practice, user input V01 and user output V11 are both provided by the same user interface, and network input V02 and network output V10 are both provided by the same network interface card.

Virtual-cluster generator V04 generates a model of a cluster in a particular configuration. Failure selector V06 allows a virtual failure to be selected, and model transformer V07 shows the result when the selected failure is applied to the modeled cluster. Typically, this result is a cluster profile, which can be converted to a model by virtual-cluster generator V04. Cluster evaluator V05 evaluates cluster models, e.g., to determine whether or not all the application programs are available. In addition, cluster evaluator V05 can be configured to output lists of single-points of failure and dual-points of failure, etc. Such evaluations can be performed on an original model or on a model resulting from a failure event or sequence. Original models and transformed models are rendered, e.g., displayed on display R17, for a user via user output V11. In addition, the model evaluation is also provided to the user.

Test sequencer V03 permits complex tests and series of tests to be performed. For example, a user can command test sequencer V03 to test the result of two or more failure events that occur together or, alternatively, in sequence. Moreover, test sequencer V03 can automatically implement a battery of tests. For example, a user can specify that all possible configurations, not just the current configuration, of cluster RCC be tested for all possible single-point and two-point failures. Alternatively, a user can command test sequencer V03 to test all possible configuration for a range of cluster designs.

Test sequencer V03 also accommodates weighting of failure events (e.g., by likelihood of occurrence) to guide test selection and to customize evaluations; for example storage disks can be more prone to failure than components without moving parts. The weighting can take into account correlations among failures. For example, the likelihood of an initially unused network interface card failing can increase after network communications are shifted to it following the failure of another network card on the same node. Likewise, the likelihood of failure of a node to which software has been migrated because of the failure of another node can increase due to the increased strain on available resources.

Moreover, test sequencer V03 allows selection of a subcluster or cluster component to be tested in lieu of the entire cluster. For example, the test object can be a cluster of a disaster-tolerant cluster of clusters, a node of a cluster, or a functional grouping of components, e.g., all disk arrays in a cluster. In other words, the failure-boundary is selectable. Thus, for example, selecting a node for testing can demonstrate components that are single-points of failure for the node, even though they are not single points of failure for the incorporating cluster. Such an analysis can, for example, suggest an optimal way to increase the robustness of a vulnerable node.

Since large numbers of tests can be involved, statistical analyzer V09 provides a convenient statistical summary of results. Optimizer V08 is used to identify optimum clusters and configurations using the statistical data. For example, it can identify a cluster configuration that withstands the most two-point failures. The output of optimizer V08 can be provided to a user for potential implementation. Also, the invention allows a user to configure cluster RCC for automatic implementation of recommended configurations.

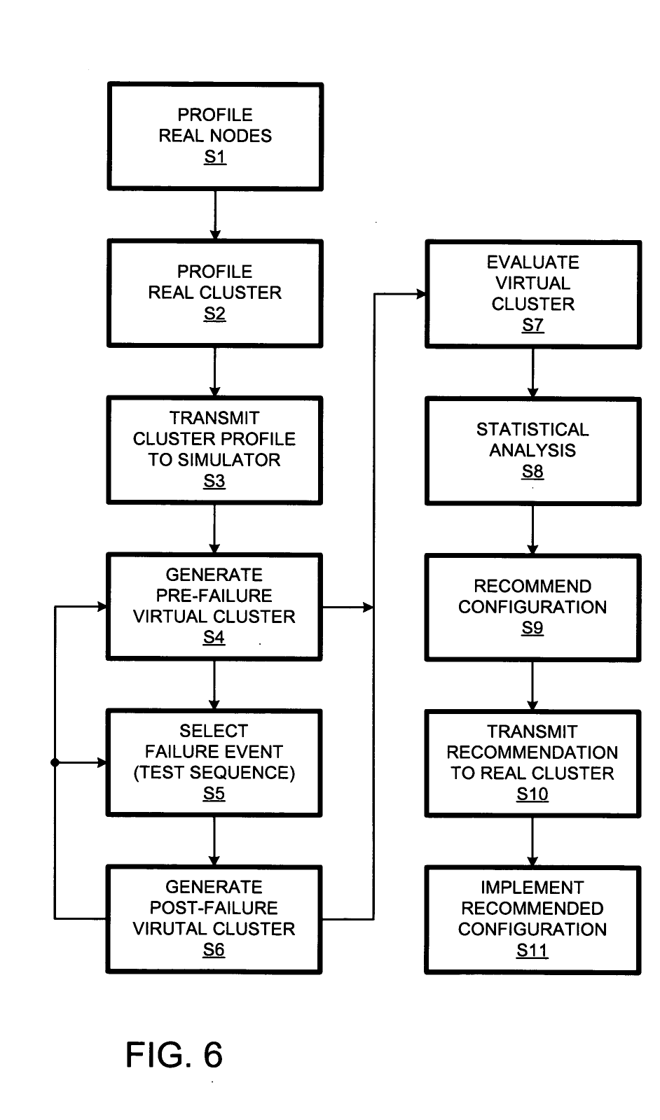

A method M1 of the invention as practiced in conjunction with simulator SIM is flow-charted in FIG. 6. At step S1, node profilers NP1, NP2, and NP3 gather configuration data from their respective nodes. This node data can include cluster-type information, such as what packages are installed and which of those are configured for use on the respective node. In addition, the profile data can include any information about the hardware and software environment associated with the respective node. At step S02, node profiler NP1 (or more generally, the node profiler currently acting as, cluster profiler) gathers the node profiles and combines them into a cluster profile. The cluster profile is transmitted to simulator SIM at step S03.

Simulator SIM generates a model of cluster RCC as it is currently configured using the cluster profile at step S04. A virtual failure event is generated at step S5. The failure event of step SOS is applied to the model of step S4 to yield a transformed model at step S6. Method M1 can cycle back to step S5, in which case an alternative failure event is applied to the original model, e.g., in the course of testing a single model for all possible single-point failures. Method M1 can also cycle back to step S4, in which case, a transformed model can be subjected to further testing, e.g., in the course of testing a given model against multi-point failures. Of course, method M1 also allows models to be tested that are specified by a user, rather than being constructed from profile data generated by the current cluster profiler.

A specified model, a model generated by a profile from the current cluster profiler, or a model resulting from a transformation can be evaluated for robustness at step S7. A series of tests can result in multiple results that can be statistically analyzed at step S8. The statistics can be used to recommend an optimum configuration or cluster design at step S9. This recommendation can be transmitted to the real cluster at step S10 and automatically implemented at step S11 by the cluster daemon acting as cluster manager, if it is configured to do this. Alternatively, the recommendation can be implemented manually by a user.

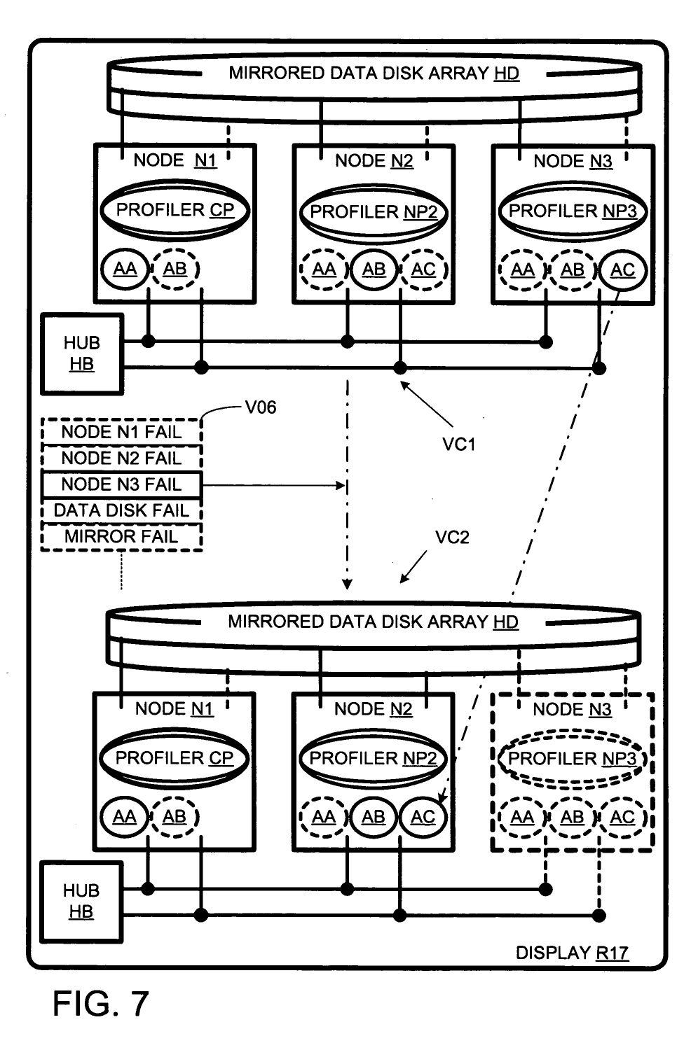

FIG. 7 shows one of the display formats for simulator SIM. Virtual cluster VC1 corresponds to cluster RCC in the configuration of FIG. 1. Menu V06 of failure events shows that a virtual failure of node N3 is to be applied to cluster VC1, resulting in virtual cluster VC2. Note that node N3 is and all its components are shown in dash-to indicate unavailability. Also note that application AC has migrated from node N3 to node N2. More specifically, cluster daemon CD1 in its role as cluster manager has caused the instance of application AC to launch on node N2 and has shifted a logical network address associated network interface card N31 of node N3 to network interface card N21 of node N2 so that the logical network address migrates with application AC. Accordingly, the logical address for accessing application AC does not change for its users.

Evaluation of virtual cluster VC2 indicates that all applications AA, AB, and AC are available. However, estimated percentages of available resources (processing cycles, memory, interface bandwidth) have increased relative to VC1. Presumably, resource utilization is still within acceptable limits so, perhaps, revival of node N3 can wait for scheduled maintenance in this scenario.

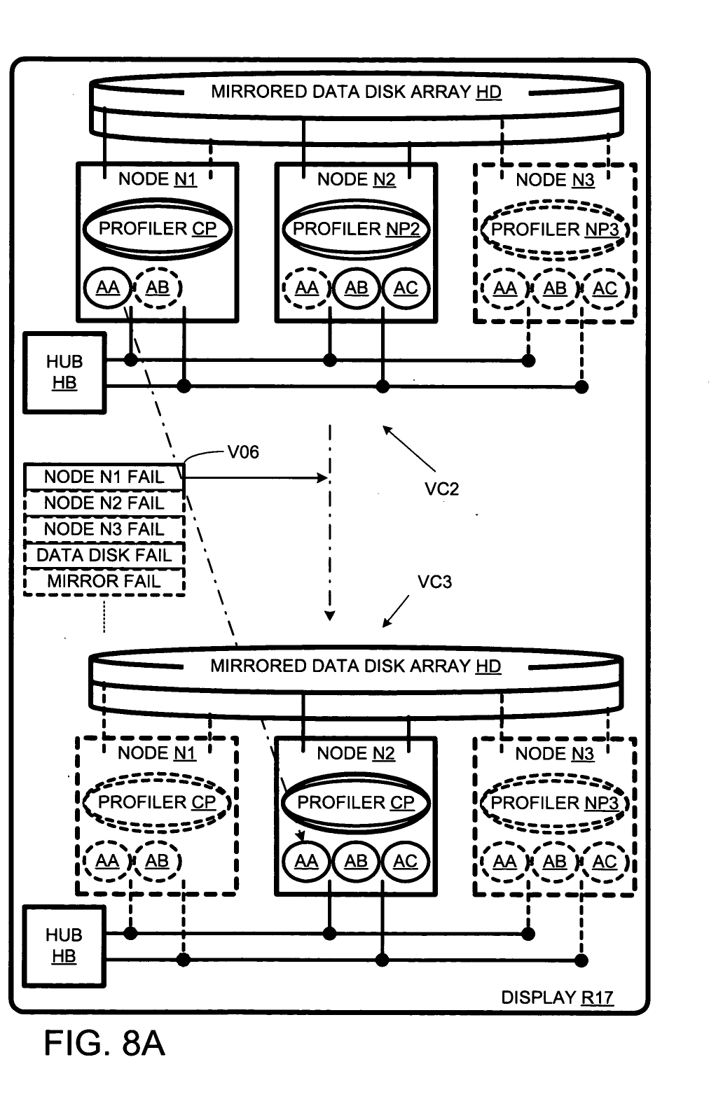

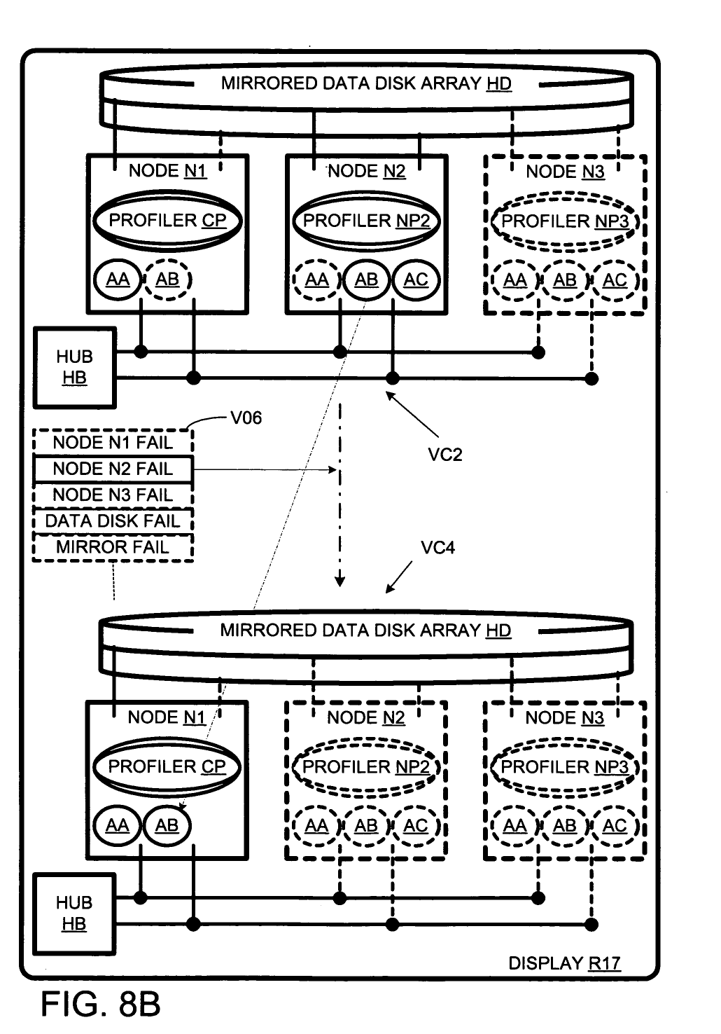

For more thorough testing of cluster RCC, a sequence of tests can be performed. Thus, a second failure can be applied as indicated in FIG. 8A, this time to virtual cluster VC2. In this case, failure of node N1 is selected and the result is virtual cluster VC3. In virtual cluster VC3, both nodes N1 and N3 are out-of-service and application AA has migrated to node N2. In addition, cluster daemon CD2 has become the current cluster manager, and node profiler NP2 serves as the current cluster profiler. An evaluation shows all three applications AA, AB, and AC are still available, but available system resources are strained, so, perhaps, unscheduled maintenance is advisable. This test shows that cluster RCC can survive the implemented sequence of two single-point failures.

FIG. 8B shows a second single-point failure test for virtual cluster VC2. In this case, node N2 fails, as indicated in virtual cluster VC4. Application AB migrates to node N1. However, application AC cannot migrate as it was not installed and configured to run on node N1. An evaluation of cluster VC4 shows that not all packages are available. This shows that cluster RCC cannot withstand all sequences of two single-point failures. If application AC is mission critical, unscheduled maintenance may be required for this failure scenario.

Testing can continue for all possible single-point failures for virtual cluster VC2. A next level of testing can be applied to all possible single-point failures of virtual cluster VC1. A third level of testing can be applied to all possible configurations of virtual cluster VC1. Statistics from the testing of all possible configurations can lead to a recommendation for a more optimal configuration, which can be manually or automatically implemented. A fourth level of testing can be applied to test different clusters and their configurations. Such testing can lead to a recommendation for additional or different hardware or to a reallocation of software.

Illustrated cluster RCC is a relatively simple cluster chosen to explain the present invention. However, the present invention applies to clusters of any complexity, including clusters that are clusters of clusters, such as a disaster-tolerant cluster. A disaster-tolerant cluster can include multiple clusters remotely located from each other and connected to each other using the Internet or some other wide-area network. Remote clusters can use transaction logs to assume the function of a cluster that fails, e.g., due to an earthquake. For such a cluster of clusters, the invention provides for simulating the entire cluster of clusters, individual clusters, and cluster components, such as individual nodes or selection functions such as disk storage or local-area networks. These and other variations upon and modification to the detailed embodiments are provided for by the present invention, the scope of which is defined by the following claims.

1. A system comprising:
a simulator including:
a virtual-failure event selector providing for selecting a virtual-failure event corresponding to a real-failure event that applies to a real computer cluster, and
a virtual-cluster generator for generating a first virtual cluster in a virtual pre-failure configuration corresponding to a real pre-failure configuration of said real computer cluster, and, in response to selection of said virtual-failure event, for generating a second virtual cluster in a virtual post-failure configuration corresponding to a real post-failure configuration of said real computer cluster.

2. A system as recited in claim 1 wherein, in said real pre-failure configuration, said real computer cluster runs a software application AC on a first computer of said real computer cluster and not on a second computer of said real computer cluster, and wherein, in said real post-failure configuration, said real computer cluster runs said application on said second computer but not on said first computer.

3. A system as recited in claim 1 further comprising said real computer cluster, said real computer cluster including profiling software for providing a descriptive profile of said real computer cluster, said virtual-cluster generator generating said virtual cluster in said pre-failure configuration using said descriptive profile.

4. A system as recited in claim 3 wherein said real computer cluster is connected to said simulator for providing said descriptive profile thereto.

5. A system as recited in claim 2 wherein said simulator further includes an evaluator for evaluating said virtual cluster in its post-failure configuration.

6. A system as recited in claim 5 wherein said simulator further includes a test sequencer, said test sequencer selecting different virtual-failure events to be applied to said first virtual cluster in said pre-failure configuration so as to result in different post-failure configurations of said virtual cluster.

7. A system as recited in claim 6 wherein said simulator further includes a statistical analyzer for statistically analyzing evaluations of said different post-failure configurations of said virtual cluster.

8. A system as recited in claim 7 wherein said test sequencer automatically tests different pre-failure configurations of said virtual cluster against different failure events, said statistical analyzer providing a determination of optimum pre-failure configuration by statistically analyzing evaluations of the resulting post-failure configurations.

9. A system as recited in claim 8 wherein said simulator is connected to said real computer cluster for providing said determination thereto, said real computer cluster automatically reconfiguring itself as a function of said determination.

10. A method comprising:
a) generating a first virtual computer cluster in a virtual pre-failure configuration that can serve as a model for a real computer cluster in a pre-failure configuration that responds to predetermined types of failures by reconfiguring to a real post-failure configuration, said reconfiguring including migrating a real application on one real computer of said real computer cluster to another real computer of said real computer cluster;
b) selecting a sequence of at least one of said predetermined types of failures; and
c) generating a second virtual computer cluster in a virtual post-failure configuration that can serve as a model for said real computer cluster in said real post--failure configuration.

11. A method as recited in claim 10 wherein steps a, b, and c are iterated for different configurations of said real computer cluster and for different sets of said predetermined failure types, said method further comprising providing a recommended configuration for said real computer cluster.

12. A method as recited in claim 10 further comprising:
gathering profile information about said real cluster in said first configuration, wherein said first virtual computer cluster is generated using said profile information.

13. A method as recited in claim 12 wherein steps a, b, and c are iterated for different configurations of said real computer cluster and for different sets of said predetermined failure types, said method further comprising providing a recommended configuration for said real computer cluster.

14. A method as recited in claim 13 further comprising:
transmitting said recommendation to said real computer cluster; and
implementing said recommended configuration on said real computer cluster.
